(19) United States
(12) Patent Application Publication
(10) Pub. No.: US 2016/0121579 A1
(43) Pub. Date: May 5, 2016

(54) Sandwich Component

(71) Applicant: Bayerische Motoren Werke Aktiengesellschaft, Muenchen (DE)

(72) Inventors: Maik HAMMER, Bruckberg (DE); Thomas SCHNEIDEWIND, Muenchen (DE)

(21) Appl. No.: 14/996,581

(22) Filed: Jan. 15, 2016

Related U.S. Application Data
(63) Continuation of application No. PCT/EP2014/063277, filed on Jun. 24, 2014.

(30) Foreign Application Priority Data
Jul. 18, 2013 (DE) 10 2013 214 103.3

(51) Int. Cl. B32B 5/24; B32B 7/02; B32B 38/14; B32B 27/20; B32B 37/16; B32B 5/02; B32B 27/12

(52) U.S. Cl. CPC B32B 5/245; B32B 5/02; B32B 7/02; B32B 27/12; B32B 27/20; B32B 37/16; B32B 38/14; B32B 2250/02; B32B 2255/102; B32B 2307/402; B32B 2307/4026; B32B 2307/412; B32B 2307/41; B32B 2605/00; B32B 2375/00; B32B 2262/106

(57) ABSTRACT

A sandwich component is provided, in particular for a visible area of a motor vehicle which area is subject to low loads. The sandwich component includes a a specifically lightweight inner core and a fiber composite cover layer which is laminated onto the inner core at least on the visible side of the sandwich component. An optically high-quality color sensitive design of the cover layer on the visible face of the component is achieved with reduced weight and at low cost in that the chromaticity of the cover layer is different from the core material per se, and the inner core is designed at least in the surface region occupied by the cover layer in the same color as the cover layer.

### CROSS REFERENCE TO RELATED APPLICATIONS

This application is a continuation of PCT International Application No. PCT/EP2014/063277, filed Jun. 24, 2014, which claims priority under 35 U.S.C. §119 from German Patent Application No. 10 2013 214 103.3, filed Jul. 18, 2013, the entire disclosures of which are herein expressly incorporated by reference.

### BACKGROUND AND SUMMARY OF THE INVENTION

The invention relates to a sandwich component, in particular for a lightly stressed visible region of a motor vehicle, composed of an internal core of light specific weight and a fiber-composite cover layer which is connected thereto in a stress-resistant manner at least on the visible side of the sandwich component.

Sandwich components of this type, on account of their potential in lightweight construction, are increasingly also used as lightly stressed trim parts in the visible region, such as the interior region, of motor vehicles. Apart from stringent weight requirements, such components also have to meet high visual quality requirements.

It is an object of the invention to configure a sandwich component of the type mentioned at the outset such that, with a reduced weight of the component and at little cost, a design of the cover layer on the visible component side is achieved which is of high visual quality and has color fidelity.

This and other objects are achieved according to the invention by a sandwich component, in particular for a lightly stressed visible region of a motor vehicle, composed of an internal core of light specific weight and a fiber-composite cover layer which is laminated onto the internal core at least on the visible side of the sandwich component. The cover layer has a color value which is different from that of the core material. The internal core at least in the surface region which is connected to the cover layer is designed so as to be of identical color to the cover layer.

According to the invention it is ensured in a manner which is simple in terms of production technology that the visual appearance of cover layers on the visible side is not compromised by the internal core situated beneath, which due to the raw material is of different color per se, and cover layers, which in a stress-adapted configuration require an extremely thin-walled and correspondingly translucent fiber-composite laminate, do not have to be oversized, so as to avoid that an internal core of different color shines through the cover-layer laminate and, on account thereof, distorts the appearance of the latter in terms of color.

Preferably, in a further simplification in terms of production technology, the internal core is pre-dyed a color identical to the cover layer in that it is covered by a color layer, such as by way of the dipping method, or else is laminated using a colored film. Alternatively and above all preferred in the case of foam cores, however, the core material is uniformly dyed by a color pigment which is added during manufacturing. In this case, likewise for reasons of production, the cover layer is expediently initially cured and then is lined on the reverse side, that is to say in particular foamed on the reverse side, with the core material which is identically dyed.

According to the invention, dark-colored and translucent fiber-composite cover layers, for example from carbon-fiber composite material, may thus be readily combined, without distorting the color or structure of the cover layer, with internal cores which in terms of material are cost effective and per se are mostly light-colored. Likewise, thin-walled fiber-composite cover layers having a transparent matrix but opaque fibrous material may assume an appearance which is throughout identical in color to the fibrous material, without abrupt color differentials at the light passages of the transparent fiber-composite matrix.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a highly schematic diagram, in an enlarged scale, showing a detail of a sandwich component which is designed according to an embodiment of the invention, having a translucent cover layer and a pre-dyed foam internal core; and

FIG. 2 is a highly schematic diagram, in enlarged scale, showing a partial section of a second exemplary embodiment having a transparent fiber-composite matrix and a coated internal core which is identical in color to the fibrous material.

### DETAILED DESCRIPTION OF THE DRAWINGS

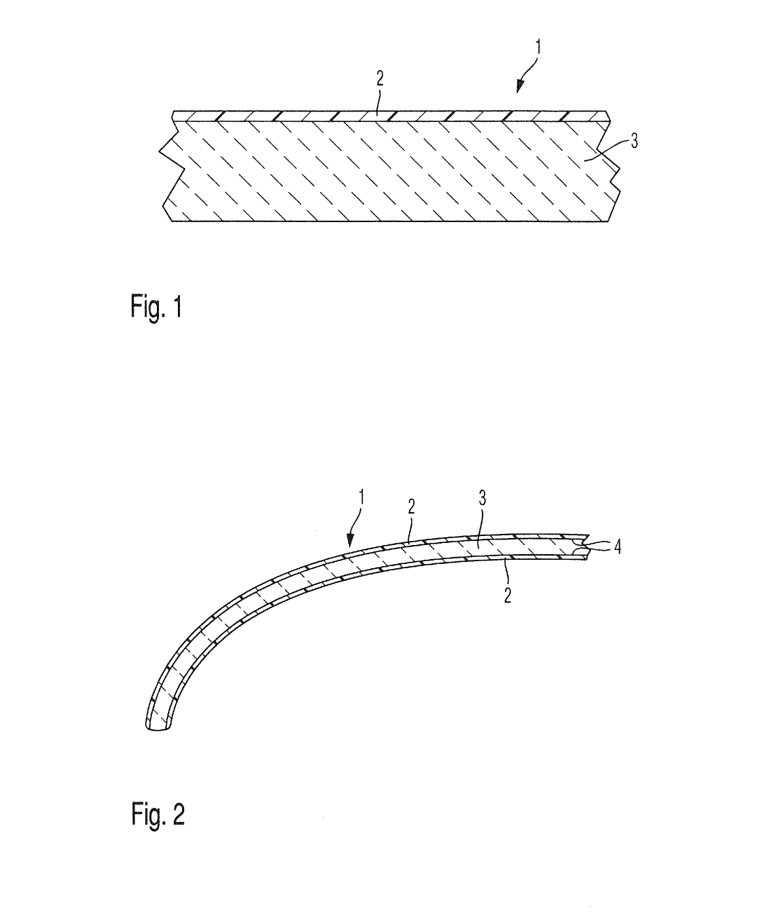

The sandwich component 1, which is partly illustrated by way of a detail in FIG. 1, is composed of a fiber-composite cover layer 2, such as from carbon-fiber composite material, and an internal core 3 of light specific weight, for example from a polyurethane foam having per se a yellowish color tone, for example, according to the material.

In the case of a stress-adapted conception of the cover layer 2, the cover layer may be dimensioned so as to be thin-walled such that the core material 3 shines through the cover layer 2 at least in a localized manner and thus distorts the appearance of the cover layer 2 in terms of color.

However, during manufacturing of the internal core 3, pigments, which are identical in color to the cover layer 2, are added to the core material, such that the cover layer 2 may be configured so as to be thin-walled and translucent, but that the sandwich component 1 nevertheless assumes a look which in relation to the cover layer 2 is pure in color and identical in structure. For reasons of simplification in terms of production technology, the cover layer 2 in this case is advantageously initially cured and then, on the reverse side, foamed with the pre-pigmented internal core material.

In the exemplary embodiment according to FIG. 2, where the components which correspond to the above-described sandwich component 1 are identified by the same reference signs, the internal core 3 has on both sides a fiber-composite cover layer 2 which, in turn, is composed of a dark fibrous material, such as carbon fibers for instance, but of a transparent fiber-composite matrix, for example of epoxy resin. The internal core 3 is pre-fabricated from a core material which is different in color to the fibrous material, such as a polyurethane foam which has a yellowish tint, such that in the case of stress-adapted thin-walled dimensioning of the cover layer 2 a yellowish and dark dotted impression of color may be created on the visible side of the sandwich component 1.

By contrast, according to FIG. 2, the internal core 3, prior to lamination of the cover layer 2, is covered across its entire area, for example by way of the dipping method, with a color layer 4 which is identical in color to the fibrous material of the cover layer 2. The completed sandwich component 1 on the cover-layer side visible surfaces therefore has a uniform color design throughout which is identical in color to the cover-layer fibers, without abrupt color differentials at the light passages of the transparent fiber-composite matrix.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A sandwich component for a visible region of a motor vehicle, which region is subject to low loads, the sandwich component comprising:
an internal core of specifically lightweight material;
a fiber composite cover layer laminated onto the inner core at least on a visible side of the sandwich component, wherein
the fiber-composite cover layer has a color different from that of the specific lightweight material of the internal core, and
the internal core having the different color is designed, at least in a surface region covered by the cover layer, to have an identical color to that of the cover layer.

2. The sandwich component according to claim 1, wherein the internal core is colored via a color pigment so as to have the identical color throughout the internal core.

3. The sandwich component according to claim 1, wherein the internal core comprises, at least in the surface region covered by the cover layer, a coating of the identical color to that of the cover layer.

4. The sandwich component according to claim 3, wherein the coating is a paint coat impermeable to light.

5. The sandwich component according to claim 3, wherein the coating is a colored film impermeable to light.

6. The sandwich component according to claim 1, wherein the internal core is a foamed core material pigmented to be identical in color to the cover layer.

7. The sandwich component according to claim 1, wherein the fiber-composite cover layer contains a transparent matrix, and wherein the internal core is designed to be identical in color to fibrous material of the fiber-composite cover layer comprising the transparent matrix.

8. A sandwich component, comprising:
a specifically lightweight inner core;
a fiber composite cover layer laminated onto the inner core at least on a visible side of the sandwich component, wherein
the cover layer and the inner core materials have different chromaticities, and
at least in a surface region of a visible area of the cover layer, the inner core has a same color as the cover layer occupying the surface region.

9. The sandwich component according to claim 8, wherein the sandwich component is a motor vehicle component in which the visible area is subject to low loads.

10. A method of producing a sandwich component for a visible area of a motor vehicle, which visible area is subject to low loads, the method comprising the acts of:
providing a fiber composite cover layer having a first color;
providing an inner core made of a specific lightweight material, the material having a second color different from the first color;
configuring the inner core to have, at least in a surface region to be covered by the cover layer, a color identical to the first color; and
laminating the color layer onto the inner core, whereby an optically high-quality color design of the cover layer on the visible area is obtained.

11. The method according to claim 10, wherein a color pigment is added to the material of the inner core so as to obtain the identical color.

12. The method according to claim 10, wherein a coating is provided on the inner core in order to provide the identical color.

13. The method according to claim 10, wherein a color film is provided on the inner core in order to provide the identical color.
